(19) United States
(12) Patent Application Publication
(10) Pub. No.: US 2026/0310887 A1
(43) Pub. Date: Oct. 8, 2026

(54) LARGE LANGUAGE MODEL-IMPLEMENTED ELECTRONIC DOCUMENT CREATION SYSTEM AND METHOD USING THE SAME

(71) Applicant: FORCS CO., LTD., Seoul (KR)

(72) Inventors: Mi Kyung PARK, Seoul (KR); Sang Hyun LEE, Goyang-si, Gyeonggi-do (KR); Jaeho CHOI, Namyangju-si, Gyeonggi-do (KR)

(21) Appl. No.: 19/363,664

(22) Filed: Oct. 21, 2025

Related U.S. Application Data
(63) Continuation of application No. PCT/KR2024/007158, filed on May 27, 2024.

(30) Foreign Application Priority Data
May 30, 2023 (KR) 10-2023-0068895

(51) Int. Cl. G06F 40/174; G06F 16/332; G06F 40/279

(52) U.S. Cl. CPC G06F 40/174; G06F 16/332; G06F 40/279

(57) ABSTRACT

An electronic document creation system includes: an electronic document creation device having an input unit configured to receive a response input including content data to be input into an entry item of an electronic document from a user terminal, a processing unit configured to generate a keyword corresponding to the content data from the response input using a large language model, and a generation unit configured to extract the content data corresponding to the entry item based on the keyword and enter the content data into the electronic document; a user terminal; a service provider terminal; and a display, connected through a network.

### BACKGROUND OF THE INVENTION

The present disclosure relates to an electronic document creation system and an electronic document creation device based on a large language model through natural language conversation, and a method for creating electronic documents using the same. For example, the present disclosure relates to a system and a device for automatically creating electronic documents by generating keywords necessary for document creation from user responses based on a large language model, and a method for creating an electronic document using the same.

In recent years, there have been many situations where documents need to be created in a non-face-to-face situation, even when people do not meet each other directly. In addition, as the types of documents that users want to create depending on the time or situation have become more diverse, the demand for companies that provide electronic documents in various fields (domains) is increasing.

To meet the needs of users, electronic document creation systems currently in use provide systems that automatically generate electronic documents for specific fields by utilizing deep learning-based language models.

However, in order to provide smooth service, fine tuning of deep learning-based document creation models is inevitable for each field, and as the number of fields provided increases, costs, such as training data collection for fine tuning and learning time, are inevitably incurred.

Accordingly, there is an increasing need for technology for an electronic document creation device that provides the system with the minimum amount of information necessary for document creation, thereby configuring an environment for creating documents by field, and thus does not require a separate additional learning process for the model.

The technology that forms the background of the present application is disclosed in Korean Patent No. 10-1705228.

The present disclosure is intended to solve the problems of the related art as described above, and to provide an electronic document creation system and an electronic document creation method using the same, which do not require an additional learning process for the model, by utilizing a large language model (LLM) rather than previously released language models, such as, a statistical language model, a neural language model, a pre-trained language model.

However, the technical objectives to be achieved by the embodiments of the present disclosure are not limited to the technical objectives described above, and other technical objectives may exist.

### SUMMARY OF THE INVENTION

As a technical means for achieving the above technical objectives, an electronic document creation system according to an embodiment of the present disclosure includes: an electronic document creation device including at least one processor, at least one memory for storing a computer program code, the computer program code, when executed by the at least one processor, is configured, with the at least one processor, to cause the electronic document creation device to: receive a response input including content data to be input into an entry item of an electronic document from a user terminal; generate a keyword corresponding to the content data from the response input using an LLM; and extract the content data corresponding to the entry item based on the keyword and enter the content data into the electronic document; the user terminal; a service provider terminal configured to input a test data; and a display, the electronic document creation device, the user terminal, the service terminal provider and the display are connected through a network, and the display is configured to display the electronic document in which the content data is entered through the user terminal.

According to an embodiment of the present disclosure, the computer program code is configured to cause the electronic document creation device to convert the response input into an input form recognizable by the LLM, but is not limited thereto.

According to an embodiment of the present disclosure, the response input includes at least one of a voice input, a text input, an image input, or a video input, but is not limited thereto.

According to an embodiment of the present disclosure, the computer program code is configured to cause the electronic document creation device to generate the keyword from the response input using a prompt including output format information for generating the keyword in a form processable by the generation unit and query information generated based on meta information including input item information for the entry item of the electronic document, but is not limited thereto.

According to an embodiment of the present disclosure, the computer program code is configured to obtain the prompt and the query information together with the response input as input of the LLM, and the prompt and the query information are received from the service provider terminal, but is not limited thereto.

According to an embodiment of the present disclosure, the prompt and the query information can be updated by a verification process that uses test data including a question and an example conversation in which a correct answer corresponding to the question is determined in advance, and determines at least one of whether the keyword derived by inputting the prompt and the query information into the LLM corresponds to a correct answer determined in advance for the example conversation and whether the keyword corresponds to the output format information, but is not limited thereto.

According to an embodiment of the present disclosure, the displayed electronic document is configured to be saved to a storage, but is not limited thereto.

Meanwhile, an electronic document creation method using an electronic document creation system according to an embodiment of the present disclosure includes: receiving a response input including content data to be input into an entry item of an electronic document from a user terminal; generating a keyword corresponding to the content data from the response input using an LLM; extracting the content data corresponding to the entry item based on the keyword and entering the content data into the electronic document; and displaying the electronic document in which the content data is entered through the user terminal using a display.

According to an embodiment of the present disclosure, the receiving includes converting the response input into an input form recognizable by the LLM, but is not limited thereto.

According to an embodiment of the present disclosure, the response input includes at least one of a voice input, a text input, an image input, and a video input, but is not limited thereto.

According to an embodiment of the present disclosure, the generation of the keyword includes generating the keyword from the response input using a prompt including output format information for generating the keyword in a form processable by the electronic document creation device and query information generated based on meta information including input item information for the entry item of the electronic document, but is not limited thereto.

According to an embodiment of the present disclosure, the electronic document creation device receives the prompt and the query information in advance from a service provider terminal, but is not limited thereto.

According to an embodiment of the present disclosure, the electronic document creation method further includes outputting the electronic document in which the content data is entered through the user terminal, but is not limited thereto.

According to an embodiment of the present disclosure, the electronic document creation method further includes saving the electronic document when the entry of the content data for all entry items of the electronic document is completed and creation of the electronic document is completed, but is not limited thereto.

According to an embodiment of the present disclosure, the response input includes a voice input and an image input, the voice input is converted into the input form recognizable by the LLM through a speech-to-text (STT), the STT including extracting a Mel-frequency cepstral coefficient (MFCC) feature vector from the voice input so as to create the voice input into a Mel spectrogram, encoding the Mel spectrogram by transforming the extracted MFCC feature vector into a sequence of discrete tokens through mapping of the MFCC feature vector using K-means clustering, and decoding the encoded MFCC feature vector so as to extract a sequence of words out of the voice input, the voice input is extracted and separated for each speaker based on the MFCC feature vector, the image input is converted into the input form recognizable by the large language model through an optical character recognition (OCR), the OCR including image preprocessing, text detection, text recognition, and post-processing, and the image preprocessing includes deskewing, a noise reduction, binarization and contrast adjustment of the image input, and the text detection includes locating and outlining the boundaries of words, lines, or paragraphs in the image input, but is not limited thereto.

The above-described technical solutions are merely exemplary and should not be construed as limiting the present disclosure. In addition to the above-described exemplary embodiments, additional embodiments may exist in the drawings and detailed description of the disclosure.

According to the technical solutions for solving the problem of the present disclosure, an LLM, rather than a general language model can be utilized for the electronic document creation system and the electronic document creation method using the same such that an additional learning process for the model is not required.

According to the aforementioned technical solutions for the technical problem of the present disclosure, by utilizing an LLM in the process of providing a system that finds the keywords from a user's response and reflects/creates the keywords in a document, an electronic document creation environment in various formats by field can be provided to the user in a short period of time without a separate learning process.

However, effects that can be obtained from the present disclosure are not limited to the effects described above, and other effects may exist.

### BRIEF DESCRIPTION OF THE DRAWINGS

FIG. 1 is a schematic diagram of an electronic document creation system according to an embodiment of the present disclosure.

FIGS. 2A-2B are conceptual diagrams for explaining the operation process of the electronic document creation system according to an embodiment of the present disclosure.

FIG. 3 is a diagram exemplarily illustrating an output result according to the input of an LLM.

FIG. 4 is a schematic diagram of an electronic document creation device according to an embodiment of the present disclosure.

FIG. 5 is a flowchart of a process for verifying a prompt of an electronic document creation system according to an embodiment of the present disclosure.

FIG. 6 is a flowchart of an electronic document creation method using the electronic document creation system according to an embodiment of the present disclosure.

FIG. 7 is a flowchart of the electronic document creation method according to an embodiment of the present disclosure. Specifically, FIG. 7 is a flowchart when an electronic document is created in a manner in which a user responds to a query of the electronic document creation device.

FIG. 8 is a flowchart of the electronic document creation method according to an embodiment of the present disclosure. Specifically, FIG. 8 is a flowchart when an electronic document is created in a manner in which a user responds to a query of an agent/a customer service representative.

### DETAILED DESCRIPTION OF THE INVENTION

Hereinafter, with reference to the attached drawings, embodiments of the present disclosure are described in detail so that those with ordinary skill in the art can easily practice the present disclosure. However, the present disclosure can be implemented in various different forms and is not limited to the embodiments described herein. In addition, in order to clearly describe the present disclosure in the drawings, parts that are not related to the description are omitted, and similar parts are assigned similar drawing reference numerals throughout the specification.

Throughout this specification, when a part is said to be “connected” to another part, this includes not only the case where it is “directly connected,” but also the case where it is “electrically connected” or “indirectly connected” with another element in between.

Throughout this specification, when it is said that an element is located “on”, “above”, “at an upper end of”, “below”, “under”, or “at a lower end of” another element, this includes not only cases where an element is in contact with another element, but also cases where another element exists between the two elements.

Throughout this specification, whenever a part is said to “include” a component, this does not mean that it excludes other components, but rather that it can include other components, unless otherwise specifically stated.

Hereinafter, the electronic document creation system of the present disclosure and the electronic document creation method using the same will be specifically described with reference to implementation examples, examples, and drawings. However, the disclosure is not limited to these implementation examples, examples, and drawings.

The present disclosure relates to an electronic document creation system based on an LLM through natural language conversation, and an electronic document creation method using the same. For example, the present disclosure relates to a system for automatically creating electronic documents by generating keywords necessary for document creation from user responses based on an LLM, and an electronic document creation method using the same.

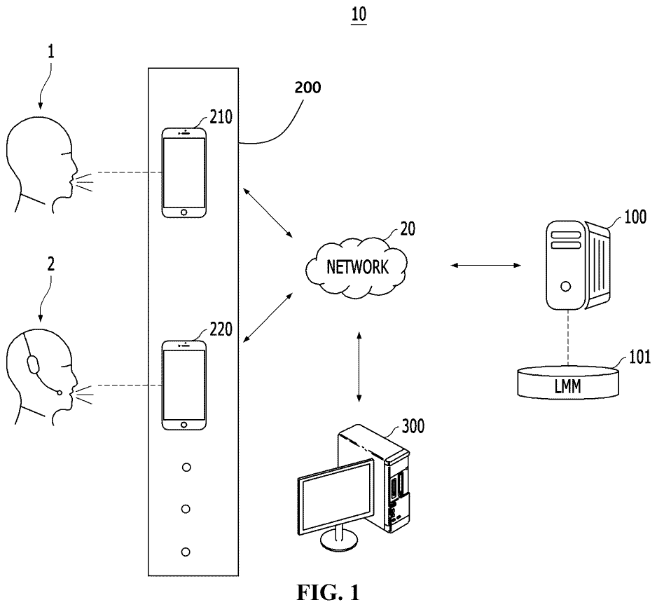

FIG. 1 is a schematic diagram of an electronic document creation system according to an embodiment of the present disclosure.

Referring to FIG. 1, an electronic document creation system 10 according to an embodiment of the present disclosure includes an electronic document creation device 100, a user terminal 200, and a service provider terminal 300 according to an embodiment of the present disclosure.

An electronic document creation device 100, a user terminal 200, and a service provider terminal 300 can communicate with each other through a network 20. The network 20 refers to a connection structure that enables information exchange between nodes, such as terminals and servers, and examples of such a network 20 include, but are not limited to, a 3rd generation partnership project (3GPP) network, an long term evolution (LTE) network, a 5G network, a world interoperability for microwave access (WIMAX) network, the Internet, a local area network (LAN), a wireless local area network (wireless LAN), a wide area network (WAN), a personal area network (PAN), a Wi-Fi network, a Bluetooth network, a satellite broadcasting network, an analog broadcasting network, a digital multimedia broadcasting (DMB) network, or the like.

For example, the user terminal 200 can be any type of wireless communication device such as a personal communication system (PCS) such as a smartphone, a smart pad, and a tablet PC, a global system for mobile communication (GMS), a personal digital cellular (PDC), a personal handy-phone system (PHS), a personal digital assistant (PDA), an international mobile telecommunication (IMT)-2000, a code division multiple access (CDMA)-2000, a W-code division multiple access (W-CDMA), or a wireless broadband Internet (Wibro) terminal.

In particular, the user terminal 200 can include various audio devices, driving devices, or the like that utilize newly emerging communication technologies, such as smart speakers, smart cars, smart appliances, wearable devices, and augmented reality devices (VR/MR).

In addition, referring to FIG. 1, in the description of the embodiment of the present disclosure, the user terminal 200 can include a plurality of terminals corresponding to each speaker to provide a response input including content data generated (converted) into an electronic document format by the electronic document creation device 100 disclosed in the present disclosure.

For example, referring to FIG. 1, the electronic document creation device 100 can obtain a conversation input including speech of a first user 1 and speech of a second user 2 from the user terminal 200, and create (generate) an electronic document based on the obtained conversation input.

As another example, although not illustrated in the drawing, according to an implementation example of the present disclosure, the electronic document creation device 100 can create an electronic document by extracting and entering content data based on a conversation input including the speech of the first user 1 received from a first user terminal 210 and the speech of the second user 2 received from a second user terminal 220.

In addition, referring to FIG. 1, as described in detail below, the electronic document creation device 100 disclosed in the present disclosure can be equipped with an LLM 101 for obtaining query information and prompts necessary for creating the electronic document in advance and generating keywords through the meta information and prompts.

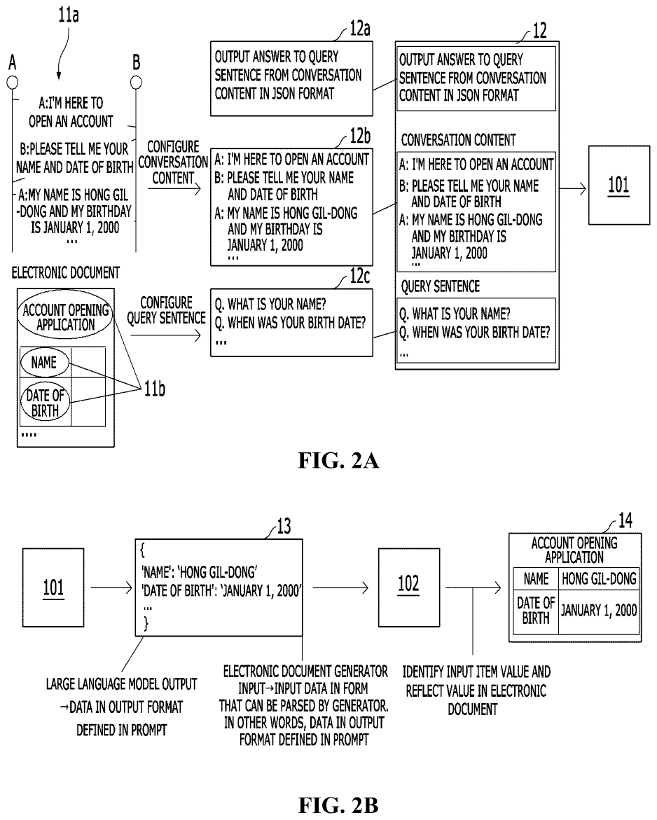

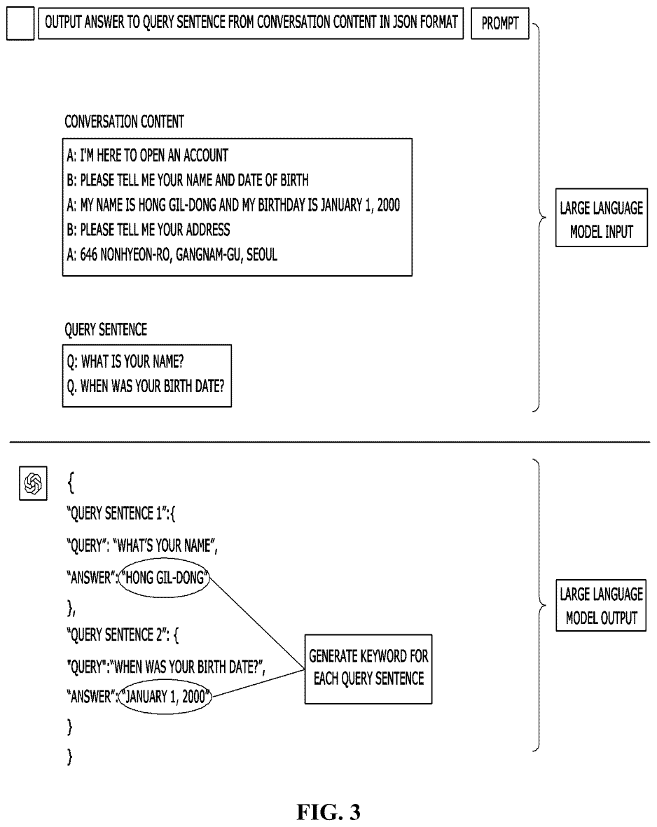

FIGS. 2A-2B are conceptual diagrams for explaining the operation process of the electronic document creation system according to an embodiment of the present disclosure.

Referring to FIGS. 2A-2B, the electronic document creation device 100 disclosed in the present disclosure can operate to obtain, as input, a natural language conversation 11a including conversation inputs performed by the first user 1 and the second user 2, and to provide, as output, an electronic document in which each input item of an electronic document format (form) to be created is entered based on a keyword derived from the natural language conversation.

In addition, the LLM 101 possessed by the electronic document creation device 100 can be used for the purpose of generating keywords to be used to enter input items of an electronic document from natural language conversation content.

More specifically, referring to FIG. 2A, the electronic document creation device 100 configures input data 12 of the LLM 101. Specifically, the input data of the LLM 101 includes a prompt 12a, a conversation content 12b, and a query sentence 12c. The prompt 12a is a part of a phrase that is transmitted to the LLM 101, and includes a phrase that instructs the model (in other words, the LLM 101, or the like) on what role the LLM should play. For example, the prompt 12a can include content (phrase) that specifies an output format, content on restrictions that prevent a result other than the specified output format from being output, or the like.

In addition, the conversation content 12b can be composed in a manner of sequentially connecting the conversation between the first user 1 and the second user 2 or the conversation between the user and the system, and the query sentence 12c can be composed based on meta information 11b including the name of each item (entry item) forming the electronic document, the type of item value, the code for each type of item value, or the like, as information that can be verified through the format of the electronic document to be created.

In addition, referring to FIG. 2B, the LLM 101 of the electronic document creation device 100 can receive input data 12 and output data (for example, text data 13, or the like) that satisfies the output format defined in the prompt 12a. More specifically, the LLM 101 can generate an answer suitable for the query sentence 12c from the input conversation content 12b and derive an output according to the format (for example, a string in JSON format) defined in the prompt 12a.

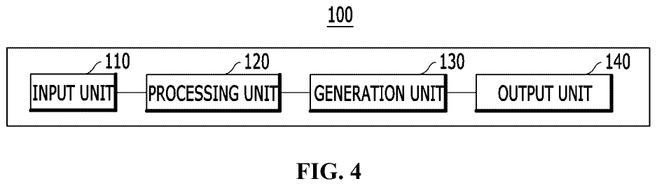

In this regard, FIG. 3 is a diagram exemplarily illustrating the output results according to the input of the LLM. More specifically, FIG. 3 illustrates the output data derived from the LLM 101 when the input data 12 is applied to the LLM 101.

Referring to FIG. 3, it can be confirmed that an output having a format different from the output format described above through FIG. 2A is derived by the LLM 101, and in the case where the format of the output data does not satisfy the predefined format, the electronic document creation device 100 can perform a modification/supplementation process so that an output of the desired format is derived by processing (enhancing) the phrase of the prompt 12a, the technical format of the query sentence 12c, or the like.

In addition, referring to FIG. 2B, the electronic document creation device 100 can transmit the output derived by the LLM 101 to an electronic document generator 102. For reference, the electronic document generator 102 can refer to the same configuration as at least one of a processing unit 120 and a generation unit 130 described below according to the implementation example of the present application, or can refer to any one of the lower modules provided in the processing unit 120 and the generation unit 130.

The electronic document generator 102 can generate the keywords for each input item of the electronic document to be created by parsing the output of an LLM 101 and reflect these keywords in the electronic document.

FIG. 4 is a schematic diagram of the electronic document creation device according to one embodiment of the present disclosure.

Referring to FIG. 4, the electronic document creation device 100 according to one embodiment of the present disclosure can include an input unit 110, the processing unit 120, and the generation unit 130. One of ordinary skill in the art would understand in light of the disclosure that the term “unit” can be a computing component including a computer processor and a memory for storing computer software codes (instructions) executable by the computer processor. Accordingly, the input unit 110, the processing unit 120, and the generation unit 130 can be implemented by a processor and a memory for storing a computer program code, and more specifically, the computer program code, when executed by the processor, can cause the electronic document creation device 100 to perform the functioning of the input unit 110, the processing unit 120, and the generation unit 130, but they are not limited thereto.

The input unit 110 can receive a response input including content data to be input in the entry item of the electronic document from the user terminal 200.

In addition, the user terminal 200 can be understood as various devices equipped with a display screen capable of displaying information about the electronic document that has been completed. When the user terminal 200 is not equipped with a display screen, an additional terminal including the display capable of displaying information about the electronic document that has been completed can be equipped.

Meanwhile, the user terminal 200 can include an application unit (not illustrated) that is linked to the electronic document creation device 100 to transmit a user input entered by the user to the electronic document creation device 100 or receive a processing result for the user input.

According to an embodiment of the present disclosure, the application unit can include a virtual artificial intelligence secretary application. The virtual artificial intelligence secretary application can include, but is not limited to, virtual artificial intelligence secretary services such as Siri, Google Assistant, Alexa, Cortana, Bixby, Nugu, Clova, or the like.

According to another embodiment of the present disclosure, the application unit can include a messenger application. The messenger application can include, but is not limited to, messenger services such as KakaoTalk, MyPeople, Line, TikTok, BuddyBuddy, SayClub, MSN Messenger, Yahoo Messenger, NateOn, DaumWizGenie, Daum Messenger, KTiman Messenger, Facebook, Telegram, and WhatsApp.

According to an embodiment of the present disclosure, the response input can be characterized by including, but not limited to, at least one of a voice input, a text input, an image input, and a video input.

The electronic document creation device 100 according to the present disclosure can receive various types of input from the user terminal 200 and create the electronic document based on the input.

According to an embodiment of the present disclosure, the input unit 110 can convert the received response input into an input form recognizable by the LLM 101, but is not limited thereto.

The electronic document creation device 100 according to the present disclosure is a device based on the LLM, and the main input form of the LLM is text. Accordingly, when the response input is not a text input, the input unit 110 can convert the response input into a form recognizable by the LLM and transmit the converted input.

For example, when the user's response input is a voice input, the voice can be converted into text through speech-to-text (STT), and when the user's response input is an image input, text information can be extracted through optical character recognition (OCR), but is not limited thereto.

As an embodiment of the present invention, the STT can include extracting features from the voice input, encoding of the extracted features, and decoding for extracting a sequence of words out of the voice input. The extracting features involve processing the raw audio waveform to pull out characteristics, such as, frequency, amplitude, and duration, while filtering out noise. More specifically, the electronic document creation device 100 can use a Short-Time Fourier Transform (STFT) to create a Mel spectrogram, showing how frequencies change over time. By adopting a Mel scale, the Mel spectrogram can better mimic human auditory perception when it is involved in speech recognition and synthesis, thereby providing a richer representation of speech features than other normal spectrograms. The Mel spectrogram can be obtained by extracting a Mel-frequency cepstral coefficient (MFCC) feature vector from the voice input and the voice of each speaker can be extracted and/or separated based on the MFCC feature vector. Consequently, the extracted features in the form of Mel spectrogram are transformed into a numerical representation suitable for the electronic document creation device 100, which involves mapping the features to a sequence of tokens or embeddings that represent the acoustic information. More specifically, the extracted voice features are transformed into the tokens by first converting them into continuous-valued vectors, which are then mapped to a discrete set of learned representations (tokens) using a quantization process, such as vector quantization. This process assigns a unique code to similar feature vectors, allowing the document creation device 100 to represent the continuous audio features as a sequence of discrete tokens, like how words form sentences. The mapping of the voice features can be conducted through K-means clustering. Next, in the decoding step, the encoded representation is translated back into human-readable text. In the decoding step, the document creation device 100 extracts the most probable sequence of words out of the voice input, considering the acoustic features and the patterns of the language. The encoded voice features can be decoded using a decoding model, a machine learning algorithm that learns to reverse the encoding process. As an illustration, the audio signals converted into Mel spectrogram fed into brain-computer interfaces (BCIs) to decode using Viterbi algorithm or Beam-Search. The Viterbi algorithm is a dynamic programming algorithm used to find the most probable sequence of hidden states in a Hidden Markov Model (HMM) given a sequence of observations. Viterbi algorithm finds the negative value in the direction that maximizes the calculation result by applying the initial state probability and state transition probability based on the HMM which is a statistical model where the system being modeled is assumed to be a Markov process with unobserved (hidden) states. In speech, these hidden states could be phonemes or sub-phonetic units. However, Viterbi algorithm has the disadvantage of taking a long time because the amount of calculation is too large, so beam-search is used to improve this. Beam-search is a heuristic search algorithm exploring a graph by expanding the most promising nodes in a limited way. Since Beam-search can reduce the computational complexity by checking the number of beams with the highest probability at each time point, instead of calculating all cases, Beam-search can be used instead of Viterbi algorithm.

As an embodiment of the present invention, the OCR, a process of converting images containing text into machine-readable text, can include image preprocessing, text detection, text recognition, and language model (post-processing). The image preprocessing can further include deskewing which corrects rotational misalignment of the image/text, despeckling or a noise reduction which removes any unwanted noise from the image, binarization which converts the image to a black and white format to clearly separate text from the background, and contrast adjustment which improves the clarity and readability of the text. After the image preprocessing, the document creation device 100, by adapting a trained deep learning model, identifies regions within the image containing text, which involves locating and outlining the boundaries of words, lines, or paragraphs using various computer vision techniques. After the text regions are detected, during the text recognition step, individual characters or words within those regions are recognized by a trained deep learning model, such as, a model combining a convolutional neural network (CNN) and a recurrent neural network (RNN). The model analyzes the shapes and patterns of the characters and compare them to known character sets or models to determine the most likely character identity. Next, the language model or the post-processing, a step of correcting errors of the recognized text, is performed. The language model helps improve accuracy by performing contextual analysis based on linguistic knowledge to correct errors based on word sequences and grammatical rules (e.g., distinguishing between “rn” and “m”), by spell-checking and dictionary validation based on correcting misrecognized words by comparing them against a dictionary or corpus of common words, and by predicting missing characters based on surrounding texts to infer potentially missing or poorly recognized characters.

The embodiments implementing the STT and OCR disclosed above are merely for illustrative purposes, and they are not limited thereto.

Meanwhile, the processing unit 120 can generate a keyword corresponding to the content data from the response input using the LLM.

The keyword includes the content data that must be created in the entry item of the electronic document, and the keyword generated in the processing unit 120 is transmitted to the generation unit 130 and processed into content data, after which the processed content data can be entered in the entry item of the electronic document.

According to an embodiment of the present disclosure, the processing unit 120 can be characterized by obtaining, as input of the LLM, query information configured based on the meta information including input item information for entry items of the electronic document together with the response input and a prompt including output format information for generating the keyword in a form processable by the generation unit 130, but is not limited thereto.

Specifically, the prompt is a part of a phrase that is transmitted to the LLM 101, and can additionally include, in addition to the output format information, phrases that instruct what role the LLM 101 should perform, content that imposes restrictions so that no other results other than the output format are produced, or the like, and keyword generation and output format control can be easily performed in the processing unit 120 during the electronic document creation process by the prompt.

The form of the prompt can include natural language that is easily understandable to humans, as well as formulas, symbols, programming languages, encrypted content, or the like, and is not particularly limited in the form as long as it can be recognized by the processing unit 120.

The output format is a form that can be parsed by the generation unit 130, and can be various formats such as JSON, xml, yaml, user-defined output, or the like, and there is no particular limitation on the format as long as it can be processed by the generation unit 130.

The meta information is information that can be verified through the format of the electronic document, and can include the names of items that make up the electronic document, types of item values, codes for each type of item value, or the like, and query information can be configured based on input item information for items entered in the electronic document among the meta information, and the electronic document creation device 100 can generate an appropriate query to induce a response including the content data for creating an electronic document from the user by obtaining the query information in advance from the service provider.

For example, when creating a vacation application form as the electronic document, the processing unit 120 can obtain query information configured in advance based on meta information including input item information for entry items of the vacation application form including “vacation start date”, “vacation end date”, “vacation reason”, and the like, by the service provider, and the electronic document creation device 100 can generate appropriate queries, such as “when is the vacation start date?”, “when is the vacation end date?”, and “what is the vacation reason?”, to induce a response including content data that must be entered in the entry items, such as the “vacation start date”, “vacation end date”, and “vacation type”, for the user.

According to an embodiment of the present disclosure, the processing unit 120 can generate the keyword from the response input using the prompt and the query information, but is not limited thereto.

When generating the keyword from the response input, the processing unit 120 can clearly determine which entry item the response input is for through the query information, thereby preventing the problem of the generation unit 130 not being able to determine which entry item the content data extracted from the keyword should be reflected in.

The processing unit 120 can also obtain the query information together with the response input through the input unit 110. In this case, the input unit 110 can configure the response input and the query information in a format set through a pre-obtained prompt so that the processing unit 120 can clearly recognize that they are input data, and transmit them to the processing unit 120.

For example, when the prompt including information for generating a noun keyword from a string following “Q:” and extracting a value from a string following “A:” is obtained together with the response input from the processing unit 120, before transmitting the response input from the input unit 110 to the processing unit 120, the processing unit 120 can transmit the response input and the meta information with the prefixes “Q:” and “A:” attached to them, respectively, so that the processing unit 120 can clearly identify which entry item the response input is for.

Meanwhile, the generation unit 130 extracts the content data corresponding to the entry item based on the keyword and enters the content data into the electronic document.

According to an embodiment of the present disclosure, the electronic document creation device 100 can include an output unit 140 that outputs the electronic document with the content data entered therein through the user terminal 200, but is not limited thereto.

In this regard, the output unit 140 can check whether content data has been properly created in an electronic document through the user terminal 200, and when there is an error in the entry of the content data, it can be corrected.

Meanwhile, the electronic document creation device 100 according to the present disclosure operates so that the electronic document is created more accurately by having a function of verifying the output form of content data output through the prompt obtained in advance by the service provider.

According to an embodiment of the present disclosure, the prompt and the query information can be updated by a verification process that uses test data including a question and an example conversation in which a correct answer corresponding to the question is determined in advance, and determines at least one of whether the keyword derived by inputting the prompt and the query information into the LLM corresponds to a correct answer determined in advance for the example conversation and whether the keyword corresponds to the output format information, but is not limited thereto.

More specifically, the electronic document creation device 100 can apply a verification process to confirm whether the processing unit 120 derives output as intended before actually providing the electronic document creation service disclosed in the present disclosure, and when performing this verification process, the prompt and query sentence composition method is applied to construct the input of the LLM 101 using test data including example conversations in which questions and correct answers corresponding to the questions are specified in advance, rather than actual conversations, and when the constructed input is transmitted, it can be verified whether the predefined correct answers and output formats are correctly reflected in the keywords derived from the processing unit 120.

In this regard, when an unintended form of output (keyword) is derived from the processing unit 120 considering the predefined correct answer and output format, the electronic document creation device 100 may repeatedly apply the verification process until the desired (intended) form of output is derived as a keyword by applying changes in prompt phrases, changes in the order of prompt phrases, advancement of the query sentence (query information) composition method/format, or the like, changes in the arrangement order between the prompt 12a, text (conversation content) 12b, and query sentence (query information) 12c when configuring the input of the LLM 101.

The verification target of the above verification process can include, but is not limited to, individual input components such as text, dates, combo boxes, and check boxes that constitute the electronic document.

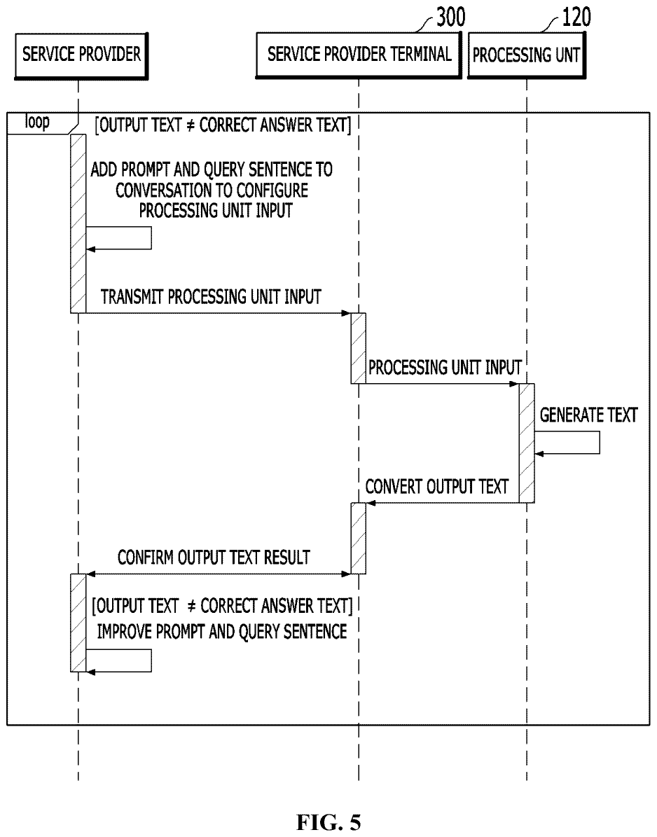

FIG. 5 is a flowchart of a process for verifying the prompt of the electronic document creation device according to an embodiment of the present disclosure.

Referring to FIG. 5, the service provider terminal 300 can apply a process of verifying and improving the prompt and the query sentence so that a desired form of output (keyword) can be derived from the processing unit 120 through the electronic document creation device 100 disclosed in the present disclosure, and the processing unit 120 of the electronic document creation device 100 can obtain the prompt and the query sentence that are optimized (updated) to correctly provide the intended output by repeatedly applying the verification process illustrated in FIG. 5. More specifically, the service provider terminal 300 can check (verify) an output (for example, an output text illustrated in FIG. 5, or the like) derived based on the test input entered by the service provider, or the like.

In addition, referring to FIG. 5, when the content data derived in response to the test input does not correspond to the preset output format (output text #correct answer text), the overall flow of the verification process for updating the prompt and query information can be checked. The process can be repeatedly performed until the content data derived through the processing unit 120 corresponds to the preset output format and correct answer, and the accuracy of the electronic document created through this verification process can be further improved.

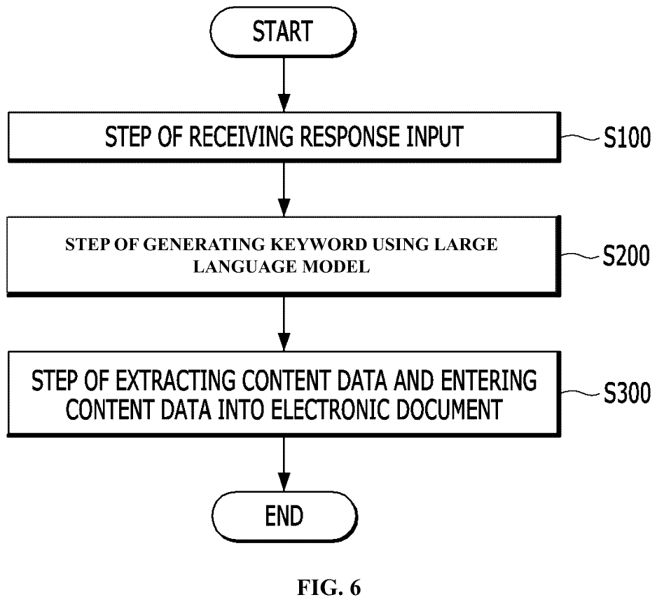

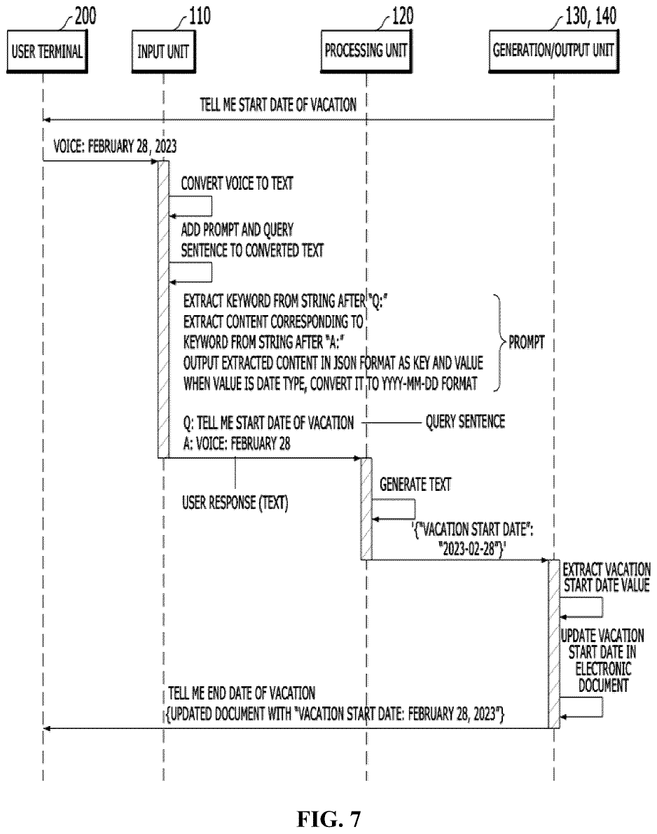

FIG. 6 is a flowchart of a method for creating the electronic document using the electronic document creation device according to an embodiment of the present disclosure.

Referring to FIG. 6, the method for creating the electronic document using the electronic document creation device according to an embodiment of the present disclosure can include a step (S100) of receiving the response input including content data to be input into an entry item of an electronic document from a user terminal, a step (S200) of generating a keyword corresponding to the content data from the response input using an LLM, and a step (S300) of extracting the content data corresponding to the entry item based on the keyword and entering the content data into the electronic document.

In the above description, the steps S100 to S300 can be further divided into additional steps or combined into fewer steps, depending on the implementation example of the present disclosure. In addition, some steps may be omitted as needed, and the order between the steps may be changed.

The electronic document creation method according to an embodiment of the present disclosure can be implemented in the form of program commands that can be executed through various computer means and recorded on a computer-readable medium. The computer-readable medium can include program commands, data files, data structures, or the like, alone or in combination. The program commands recorded on the medium can be those specially designed and configured for the present disclosure or can be those known to those skilled in the art of computer software and available for use. Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program commands such as ROMs, RAMs, flash memories, or the like. Examples of the program commands include not only machine language codes generated by a compiler, but also high-level language codes that can be executed by a computer using an interpreter, or the like. The hardware devices described above can be configured to operate as one or more software modules to perform the operations of the present disclosure, and vice versa.

Additionally, the aforementioned electronic document creation method can also be implemented in the form of a computer program or application executed by a computer stored in a recording medium.

In addition, the electronic document creation method according to the present disclosure can be performed in a form in which the user responds to the query of the electronic document creation device 100, a form in which the user responds to a query of an agent or a customer service representative, or the like, but is not limited thereto.

Below, the electronic document creation method will be described in more detail. In the following description, it is assumed that the electronic document is a vacation application, but this is only for convenience of explanation and the electronic document is not limited to a vacation application.

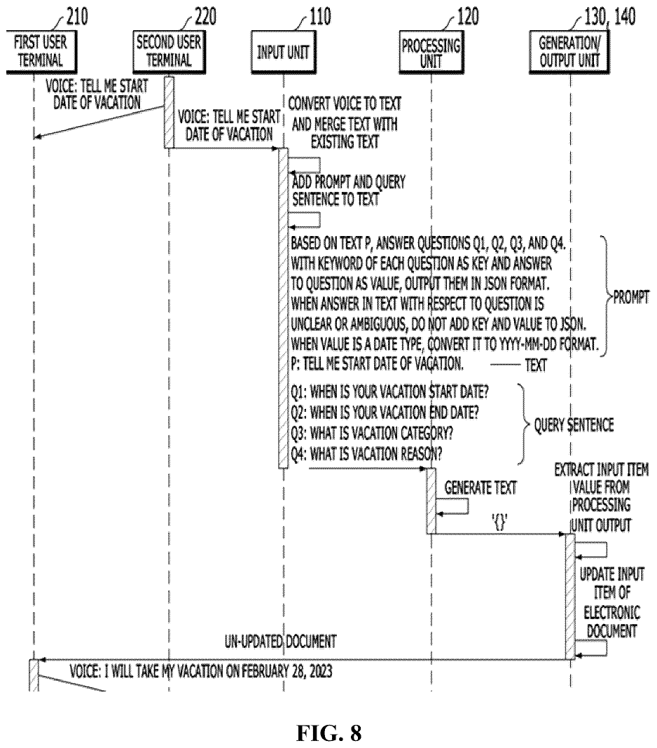

FIG. 7 is a flowchart of the electronic document creation method according to an embodiment of the present disclosure. Specifically, FIG. 7 is a flowchart when the electronic document is created in a manner in which the user responds to the query of the electronic document creation device.

Referring to FIG. 7, first, the response input including the content data to be input in the entry item of the electronic document is received from the user terminal (S100).

In addition, referring to FIG. 7, the query for inducing the user's response including the content data to be input in the entry item of the electronic document for creating the electronic document can be transmitted to the user terminal, and the user can respond to the query on the user terminal and transmit the response input to the input unit 110.

In this case, there are cases where the user's response input does not include input item information of the electronic document, and thus the generation unit 130 does not know which item to reflect the value in.

Therefore, in order to prevent the problem of not being able to determine where to reflect the value in the generation unit 130, when transmitting data from the input unit 110 to the processing unit 120, the meta information such as the system query is transmitted together with the response input so that the processing unit 120 can clearly detect which input item the response is for. That is, as the prompt and system query are added, the data transmitted from the input unit 110 to the processing unit 120 can include prompts, query sentences, and user answers (text) converted into text form as inputs for the LLM 101.

Meanwhile, before combining meta information with the response input and transmitting the data to the processing unit 120, it must be configured in an input format that corresponds to the prompt so that the processing unit 120 can clearly recognize that it is input data.

Referring to FIG. 7, when the prompt including information instructing the processing unit 120 to generate a noun keyword from a string following “Q:” and to extract a value from a string following “A:” is obtained, before transmitting data from the input unit 110 to the processing unit 120, a system query (meta information) and a user response (response input) can be transmitted with a prefix such as “Q:” and “A:” attached to them, respectively, so that the processing unit 120 can clearly identify them.

Next, the LLM is used to generate the keyword corresponding to the content data from the response input (S200).

The processing unit 120 can generate the keyword corresponding to content data through the response input and meta information received through the input unit 110, convert the keyword specified through the prompt into an output format for generating the keyword in a form that can be processed by the generation unit 130, and transmit the keyword to the generation unit 130.

Referring to FIG. 7, in a case where the prompt includes content to set the output format to JSON and display the date in the YYYY-MM-DD format, when properly processed by the processing unit 120, the keyword including the JSON string {“vacation start date”: “2023 Feb. 28”} can be transmitted to the generation unit 130.

Next, content data corresponding to the entry items is extracted based on the keyword, and the content data is entered into the electronic document (S300).

The generation unit 130 can extract the content data corresponding to the entry items of the electronic document based on the received keywords and enter the content data into the actual electronic document input items.

According to an embodiment of the present disclosure, the method can further include, but is not limited to, a step of outputting the electronic document in which the content data is entered through the user terminal.

Referring to FIG. 7, the output unit can output an electronic document with the “vacation start date” item updated through the user terminal so that the electronic document in which the content data derived in response to the response input is entered can be confirmed. In addition, for items that have not yet been answered other than “vacation start date”, when the user responds to the system's additional query through the input unit 110, the output unit can confirm the same through a series of processes described above.

According to an embodiment of the present disclosure, when the entry of the content data for all entry items of the electronic document is completed and the creation of the electronic document is completed, the method can further include, but is not limited to, a step of storing the electronic document.

The electronic document creation device 100 can store the completed electronic document when the creation of the electronic document is completed by completing the entry of content data for all entry items included in the electronic document.

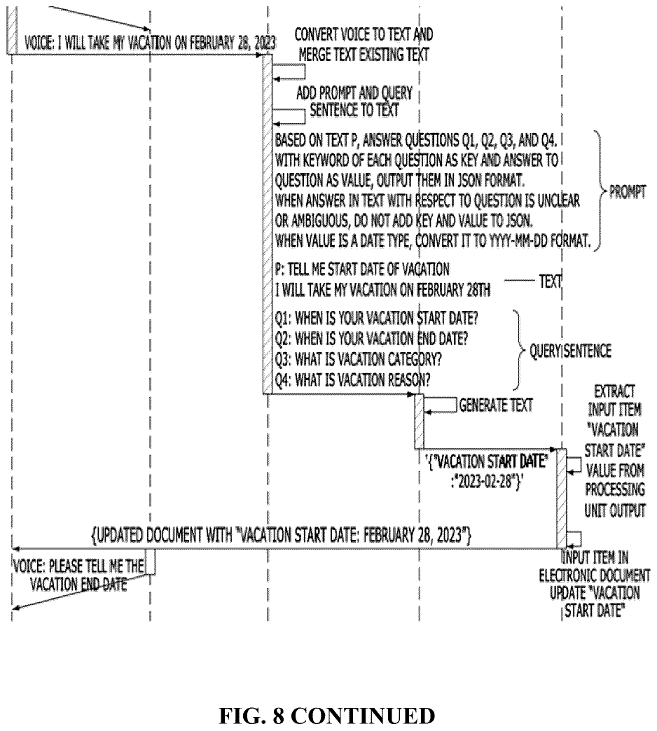

FIG. 8 is a flowchart of the electronic document creation method according to an embodiment of the present disclosure. Specifically, FIG. 8 is a flowchart when the electronic document is created in a manner in which the user responds to the agent/customer service representative's query.

Referring to FIG. 8, the query for inducing the user's response including the content data to be input in the entry item of the electronic document for creating the electronic document can be transmitted from the agent/customer service representative's terminal to the user terminal. At the same time, the query is transmitted to an electronic document creation device 100, and the electronic document that has not been updated based on the query can be transmitted to the user terminal. The user can respond to the query, thereby transmitting a response input to the input unit 110 at the user terminal.

For reference, although FIG. 8 illustrates that the first user terminal 210 corresponding to the first user (user) and the second user terminal 220 corresponding to the second user (agent and/or customer service representative) are separate devices, this is to distinguish each speaker included in the conversation input, and according to the implementation example of the present disclosure, it can be understood to encompass a state in which the conversation input by the first user and the second user is obtained using a single device (for example, the user terminal 200 illustrated in FIG. 1, or the like).

As stated above, when the conversation input is converted into a Mel spectrogram, the voice of each user can be separately extracted based on the MFCC feature vector.

In addition, referring to FIG. 8, when transmitting the response input from the input unit 110 to the processing unit 120, the generation unit 130 can transmit together meta information including input item information of the electronic document in a form identifiable by the processing unit 130 regarding which input item of the electronic document to fill in. That is, as the prompt and system query are added, the data transmitted from the input unit 110 to the processing unit 120 can include the prompt, the query sentence, and text-type data (text) as the input to the LLM 101.

For example, when the prompt including information instructing to find an answer to the question following “QN:” (N is a natural number) or to infer an answer is obtained in the text following “P:” in the processing unit 120, before transmitting data from the input unit 110 to the processing unit 120, the processing unit 120 can transmit the system query (meta information) and the user-agent/customer service representative conversation by adding a prefix such as “QN:” or “P:” to each of them to clearly identify.

Referring to FIG. 8, the agent/customer service representative's query and the user's response input can be converted into text in the input unit 110 and then transferred to the processing unit 120 by being connected to the text previously converted in the input unit 110.

The above description of the present disclosure is for illustrative purposes only, and those skilled in the art will understand that the present disclosure can be easily modified into other specific forms without changing the technical idea or essential features of the present disclosure. Therefore, it should be understood that the embodiments described above are exemplary in all respects and not restrictive. For example, each component described as a single component can be implemented in a distributed manner, and likewise, components described as distributed can be implemented in a combined manner.

The scope of the present application is indicated by the claims described below rather than the detailed description above, and all changes or modifications derived from the meaning and scope of the claims and their equivalent concepts should be interpreted as being included in the scope of the present application.

1. An electronic document creation system comprising:
an electronic document creation device including:
at least one processor; and
at least one memory for storing a computer program code,
wherein the computer program code, when executed by the at least one processor, is configured, with the at least one processor, to cause the electronic document creation device to:
receive a response input including content data to be input into an entry item of an electronic document from a user terminal;
generate a keyword corresponding to the content data from the response input using a large language model; and
extract the content data corresponding to the entry item based on the keyword and enter the content data into the electronic document;
the user terminal;
a service provider terminal configured to input a test data; and
a display,
wherein the electronic document creation device, the user terminal, the service terminal provider and the display are connected through a network, and
wherein the display is configured to display the electronic document in which the content data is entered through the user terminal.

2. The electronic document creation system of claim 1, wherein the computer program code is configured to cause the electronic document creation device to convert the response input into an input form recognizable by the large language model.

3. The electronic document creation system of claim 2, wherein the response input includes at least one of a voice input, a text input, an image input, or a video input.

4. The electronic document creation system of claim 1,
wherein the computer program code is configured to cause the electronic document creation device to generate:
the keyword from the response input using a prompt including output format information such that the keyword is generated in a form processable by the at least one processor; and
query information based on meta information including input item information for the entry item of the electronic document.

5. The electronic document creation system of claim 4, wherein the computer program code is configured to cause the electronic document creation device to obtain the prompt and the query information together with the response input, as input of the large language model, and the prompt and the query information are received from the service provider terminal.

6. The electronic document creation system of claim 5, wherein the prompt and the query information are updateable by a verification process that uses the test data including a question and an example conversation,
wherein a correct answer corresponding to the question is determined in advance for the example conversation and the keyword is derived by inputting the prompt and the query information into the large language model, and the verification process is performed by determining at least one of whether the correct answer corresponds to the keyword or whether the keyword corresponds to the output format information.

7. The electronic document creation system of claim 1, wherein the displayed electronic document is configured to be saved to a storage.

8. An electronic document creation method using an electronic document creation system, the electronic document creation method comprising:
receiving a response input including content data to be input into an entry item of an electronic document from a user terminal;
generating a keyword corresponding to the content data from the response input using a large language model;
extracting the content data corresponding to the entry item based on the keyword and entering the content data into the electronic document; and
displaying the electronic document in which the content data is entered through the user terminal using a display.

9. The electronic document creation method of claim 8, wherein the receiving includes converting the response input into an input form recognizable by the large language model.

10. The electronic document creation method of claim 9, wherein the response input includes at least one of a voice input, a text input, an image input, and a video input.

11. The electronic document creation method of claim 8, wherein the generating of the keyword includes:
generating the keyword from the response input using a prompt including output format information such that the keyword is generated in a form processable by the electronic document creation device; and
generating query information based on meta information including input item information for the entry item of the electronic document.

12. The electronic document creation method of claim 11, wherein the electronic document creation device receives the prompt and the query information in advance from a service provider terminal.

13. The electronic document creation method of claim 12, wherein the prompt and the query information are updated through a verification process that transmits a test input including test data to the electronic document creation device and determines whether the content data derived in response to the test input corresponds to a preset output format.

14. The electronic document creation method of claim 8, further comprising saving the electronic document when entry of the content data for all entry items of the electronic document is completed and creation of the electronic document is completed.

15. The electronic document creation system of claim 2,
wherein the response input includes a voice input and an image input,
wherein the voice input is converted into the input form recognizable by the large language model through a speech-to-text (STT), the STT including extracting a Mel-frequency cepstral coefficient (MFCC) feature vector from the voice input so as to create the voice input into a Mel spectrogram, encoding the Mel spectrogram by transforming the extracted MFCC feature vector into a sequence of discrete tokens through mapping of the MFCC feature vector using K-means clustering, and decoding the encoded MFCC feature vector so as to extract a sequence of words out of the voice input,
wherein the voice input is extracted and separated for each speaker based on the MFCC feature vector,
wherein the image input is converted into the input form recognizable by the large language model through an optical character recognition (OCR), the OCR including image preprocessing, text detection, text recognition, and post-processing, and
wherein the image preprocessing includes deskewing, a noise reduction, binarization and contrast adjustment of the image input, and the text detection includes locating and outlining the boundaries of words, lines, or paragraphs in the image input.

16. The electronic document creation method of claim 9,
wherein the response input includes a voice input and an image input,
wherein the voice input is converted into the input form recognizable by the large language model through a speech-to-text (STT), the STT including extracting a Mel-frequency cepstral coefficient (MFCC) feature vector from the voice input so as to create the voice input into a Mel spectrogram, encoding the Mel spectrogram by transforming the extracted MFCC feature vector into a sequence of discrete tokens through mapping of the MFCC feature vector using K-means clustering, and decoding the encoded MFCC feature vector so as to extract a sequence of words out of the voice input,
wherein the voice input is extracted and separated for each speaker based on the MFCC feature vector,
wherein the image input is converted into the input form recognizable by the large language model through an optical character recognition (OCR), the OCR including image preprocessing, text detection, text recognition, and post-processing, and
wherein the image preprocessing includes deskewing, a noise reduction, binarization and contrast adjustment of the image input, and the text detection includes locating and outlining the boundaries of words, lines, or paragraphs in the image input.
